(19) United States
(12) Patent Application Publication
(10) Pub. No.: US 2004/0122783 A1
(43) Pub. Date: Jun. 24, 2004

(54) String search neuron for artificial neural networks

(76) Inventors: Donald F Specht, Los Altos, CA (US); Guy Paillet, Corte Madera, CA (US)

Correspondence Address: Johnson & Stainbrook, Suite 203, 3550 Round Barn Boulevard, Santa Rosa, CA, 95403, US

(21) Appl. No.: 10/474,104

(22) PCT Filed: Apr. 8, 2002
(86) PCT No.: PCT/US02/10966

(30) Foreign Application Priority Data
Apr. 6, 2001 (US) 60282012

(51) Int. Cl. G06G 7/00; G06F 15/18; G06E 1/00; G06E 3/00; G06N 3/02

(52) U.S. Cl. 706/6; 706/15

(57) ABSTRACT

An improved neuron and corresponding search operation for use in matching strings of characters from a character set or strings of pixels from an image is at least partly based on ZISC technology. Each neuron contains only one character in the string of characters to be searched or, equivalently, one pixel in the image to be searched. The neurons are lined up in order (unlike standard ZISC). The inventive system matches two strings of base-pairs, one of which is stored in the neurons, and the other of which is entered into the system input one character at a time and thereafter broadcast to all of the neurons. The inputs, outputs and contents of each neuron in the system include one stored base pair, a left_errors register; a right_errors register; a parallel sort bus; and a neuron number or location register. The operation may include the following steps: at the start of the operation, all left_errors and right_errors registers are reset to “0”. When one base-pair is entered into the system input, all neurons compare it to their own stored base-pair. If it is the same, right_errors=left_errors+0 (which becomes left_errors to the next neuron in the left to right arrangement). If it is different, right_errors=left_errors+1. This operation continues for all of the base-pairs in the input sub string. At the end of the sub string of “m” characters, each right-errors register will record the number of errors (or mismatched pairs) in the “m” characters to the left of its position in the sequence (including itself). A “0” result indicates that there was a perfect match of the input to this part of the sequence. A “1” indicates that there is an almost perfect match with only one mismatch. A “2” through “6” result indicates that number of mismatches. If left_errors equals “7”, then right_errors will always equal “7”. The fourth bit indicates that an end of the stored substring character has been reached. When this bit is turned on, then left_errors will always be transferred to right_errors unchanged until the end of the input sub string. At the end of an input sub string (i.e., the end of a search), a parallel search in the manner of a standard ZISC search is performed.

### PRIORITY CLAIM

This application claims the benefit of U.S. Provisional Application Serial No. 60/282,012, filed Apr. 6, 2001.

### BACKGROUND OF THE INVENTION

1. Technical Field

The present invention relates generally to artificial neural network systems, and more particularly to an improved string search neuron for use in such neural networks.

2. Background Art

U.S. Pat. No. 5,621,863 discloses an improved neuron circuit that generates local result signals, e.g. of the fire type, and a local output signal of the distance or category type. The neuron circuit which is connected to buses that transport input data (e.g. the input category) and control signals. A multi-norm distance evaluation circuit calculates the distance D between the input vector and a prototype vector stored in a R/W memory circuit. A distance compare circuit compares this distance D with either the stored prototype vector's actual influence field or the lower limit thereof to generate first and second comparison signals. An identification circuit processes the comparison signals, the input category signal, the local category signal and a feedback signal to generate local result signals that represent the neuron circuit's response to the input vector. A minimum distance determination circuit determines the minimum distance Dmin among all the calculated distances from all of the neuron circuits of the neural network and generates a local output signal of the distance type. The circuit may be used to search and sort categories. The feed-back signal is collectively generated by all the neuron circuits by ORing all the local distances/categories. A daisy chain circuit is serially connected to corresponding daisy chain circuits of two adjacent neuron circuits to chain the neurons together. The daisy chain circuit also determines the neuron circuit state as free or engaged. Finally, a context circuitry enables or inhibits neuron participation with other neuron circuits in generation of the feedback signal.

U.S. Pat. No. 5,701,397 teaches a circuit for pre-charging a free neuron circuit wherein each neuron in a neural network of a plurality of neuron circuits either in an engaged or a free state, a pre-charge circuit, that allows loading the components of an input vector only into a determined free neuron circuit during a recognition phase as a potential prototype vector attached to the determined neuron circuit. The pre-charge circuit is a weight memory controlled by a memory control signal and the circuit generating the memory control signal. The memory control signal identifies the determined free neuron circuit. During the recognition phase, the memory control signal is active only for the determined free neuron circuit. When the neural network is a chain of neuron circuits, the determined free neuron circuit is the first free neuron in the chain. The input vector components on an input data bus are connected to the weight memory of all neuron circuits. The data therefrom are available in each neuron on an output data bus. The pre-charge circuit may further include an address counter for addressing the weight memory and a register to latch the data output on the output data bus. After the determined neuron circuit has been engaged, the contents of its weight memory cannot be modified. Pre-charging the input vector during the recognition phase makes the engagement process more efficient and significantly reduces learning time in learning the input vector.

U.S. Pat. No. 5,710,869 describes a daisy chain circuit for serial connection of neuron circuits wherein each daisy chain circuit is serially connected to the two adjacent neuron circuits, so that all the neuron circuits form a chain. The daisy chain circuit distinguishes between the two possible states of the neuron circuit (engaged or free) and identifies the first free “or ready to learn” neuron circuit in the chain, based on the respective values of the input and output signals of the daisy chain circuit. The ready to learn neuron circuit is the only neuron circuit of the neural network having daisy chain input and output signals complementary to each other. The daisy chain circuit includes a 1-bit register controlled by a store enable signal which is active at initialization or, during the learning phase when a new neuron circuit is engaged. At initialization, all the Daisy registers of the chain are forced to a first logic value. The DCI input of the first daisy chain circuit in the chain is connected to a second logic value, such that after initialization, it is the ready to learn neuron circuit. In the learning phase, the ready to learn neuron's 1-bit daisy register contents are set to the second logic value by the store enable signal, it is said “engaged”. As neurons are engaged, each subsequent neuron circuit in the chain then becomes the next ready to learn neuron circuit.

U.S. Pat. No. 5,717,832 discloses a neural semiconductor chip and incorporated neural networks including a base neural semiconductor chip including a neural network or unit. The neural network has a plurality of neuron circuits fed by different buses transporting data such as the input vector data, set-up parameters, and control signals. Each neuron circuit includes logic for generating local result signals of the “fire” type and a local output signal of the distance or category type on respective buses. An OR circuit performs an OR function for all corresponding local result and output signals to generate respective first global result and output signals on respective buses that are merged in an on-chip common communication bus shared by all neuron circuits of the chip. In a multi-chip network, an additional OR function is performed between all corresponding first global result and output signals (which are intermediate signals) to generate second global result and output signals, preferably by dotting onto an off-chip common communication bus in the chip's driver block. This latter bus is shared by all the base neural network chips that are connected to it in order to incorporate a neural network of the desired size. In the chip, a multiplexer may select either the intermediate output or the global output signal to be fed back to all neuron circuits of the neural network, depending on whether the chip is used in a single or multi-chip environment via a feed-back bus. The feedback signal is the result of a collective processing of all the local output signals.

U.S. Pat. No. 5,740,326 teaches a circuit for searching/sorting data in a neural network of N neuron circuits, having an engaged neuron's calculated p bit wide distance between an input vector and a prototype vector and stored in the weight memory thereof, an aggregate search/sort circuit of N engaged neurons' search/sort circuits. The aggregate search/sort circuit determines the minimum distance among the calculated distances. Each search/sort circuit has p elementary search/sort units connected in series to form a column, such that the aggregate circuit is a matrix of elementary search/sort units. The distance bit signals of the same bit rank are applied to search/sort units in each row. A feedback signal is generated by ORing in an OR gate all local search/sort output signals from the elementary search/sort units of the same row. The search process is based on identifyig zeroes in the distance bit signals, from the MSB's to the LSB's. As a zero is found in a row, all the columns with a one in that row are excluded from the subsequent row search. The search process continues until only one distance, the minimum distance, remains and is available at the output of the OR circuit The above described search/sort circuit may further include a latch allowing the aggregate circuit to sort remaining distances in increasing order.

### DISCLOSURE OF INVENTION

The string search neuron for artificial neural networks of the present invention provides an improved neuron and corresponding search operation for use in matching strings of characters from a character set or strings of pixels from an image. The inventive string search neuron is at least partly based on ZISC technology (Zero Instruction Set Computer, ZISC is a trademark of International Business Machines Corporation). In the inventive system, each neuron contains only one character in the string of characters to be searched or, equivalently, one pixel in the image to be searched. While the inventive concept can be extended to other character sets, for purposes of illustration herein a preferred character set consists of A, G, C, and T, representing the base pairs in DNA (adenine, guanine, cytosine, and thymine), or the equivalent set for RNA. The system will be described first in terms of this character set. Then it will be shown that the basic concepts can apply to other character sets and to arrays of data in one, two, three, or higher dimensions.

The neurons are lined up in order (unlike standard ZISC). The inventive system matches two strings of base-pairs, one of which is stored in the neurons, and the other of which is entered into the system input one character at a time and thereafter broadcast to all of the neurons. Both strings can be long, and both can be divided into sub strings concatenated together.

The inputs, outputs and contents of each neuron in the system include:

(1) One stored base pair: preferably three (3) bits of storage (Note: while two bits would be enough to identify any of the four possible base pairs A, G, C, or T, three bits of storage provides up to eight combinations. Thus, in addition to the four possible base pairs A, G, C, or T, these combinations can include “N” representing “unknown”, and an additional character to indicate the end of a particular sub string)

(2) Left_errors Register: number of errors from the last neuron/left neighbor; preferably three (3) bits of storage

(3) Right_errors Register: number of errors to the next neuron/right neighbor; preferably three (3) bits of storage

(4) Parallel Sort Bus: preferably one (1) bit output registered (ORed) with all the other neurons in the system; and

(5) Neuron number or location register: preferably having a sufficient number of bits to give a unique number to each neuron (e.g., 32 bits of storage).

The operation of the inventive string search preferably includes the following steps: At the start of the operation, all left_errors and right_errors registers are reset to “0”. When one base-pair is entered into the system input, all neurons compare it to their own stored base-pair. If it is the same, right_errors=left_errors+0 (which becomes left_errors to the next neuron in the left to right arrangement). If it is different, right_errors=left_errors+1.

If “N” (unknown) is entered in the input, the number of errors is not incremented.

If “N” is stored in the neuron, it is considered the same as an error.

This operation continues for all of the base-pairs in the input sub string. At the end of the sub string of “m” characters, each right_errors register will record the number of errors (or mismatched pairs) in the “m” characters to the left of its position in the sequence (including itself). A “0” result indicates that there was a perfect match of the input to this part of the sequence. A “1” indicates that there is an almost perfect match with only one mismatch (known as an SNP, or single nucleotide polymorphism). A “2” through “6” result indicates that number of mismatches. If left_errors equals “7”, then right_errors will always equal “7”. The fourth bit indicates that an end of the stored substring character has been reached (probably a carriage return). When this bit is turned on, then left errors will always be transferred to right_errors unchanged until the end of the input sub string.

At the end of an input sub string (i.e., the end of a search), a parallel search in the manner of a standard ZISC search is performed. This will output the value of the smallest right error of any neuron in the system and its location (its neuron number). If the smallest error is “0”, then an exact match has been detected. If it is “1”, then it has detected an SNP. If it is “2” through “6”, a poorer match has been detected; and if it is “7”, it has detected no match at all.

Advantages of the inventive string search neuron, as compared to standard ZISC technology, include but are not limited to the following:

1) The stored string must be stored only once, instead of once per possible starting position in 64.

2) All mismatches are counted the same, versus different pairs being counted as 1, 2, or 3.

3) There is no restriction on the length of a sub string.

4) It can detect single nucleotide polymorphisms (SNPs) directly.

5) Only 3 bits are required for storage of a base-pair, rather than 8 bits for standard ZISC, or 64 bits for a supercomputer.

Alternate embodiments of the inventive technology include, but are not limited to, the following:

The error counter could include more or fewer than three (3) bits. For example, one (1) bit would be sufficient if one is searching for exact matches only.

The preferred embodiment includes a register in each neuron to indicate neuron number. This would be clocked out from the first neuron with minimum error (as in standard ZISC). The register could be hard-coded and different for each neuron, or RAM that is loaded as part of the initialization procedure.

An alternate embodiment has no register whatsoever, and requires a serial scan of the error registers to find the first one with the minimum error.

### BRIEF DESCRIPTION OF THE DRAWINGS

FIG. 1 is a schematic diagram of a string search neuron of the present invention (optimized for DNA/RNA sequences);

FIG. 2 is a printout of a console output from a program string search;

FIG. 3 is a printout of the output data of a simulated string search for a string of 12 characters showing search results for each clock cycle for 12 successive cycles;

FIG. 4 is a schematic diagram of an alternate string search neuron of the present invention (optimized for text); and

FIG. 5 is a schematic diagram of an alternate string search neuron of the present invention as organized for search of image sub blocks in an image.

### BEST MODE FOR CARRYING OUT THE INVENTION

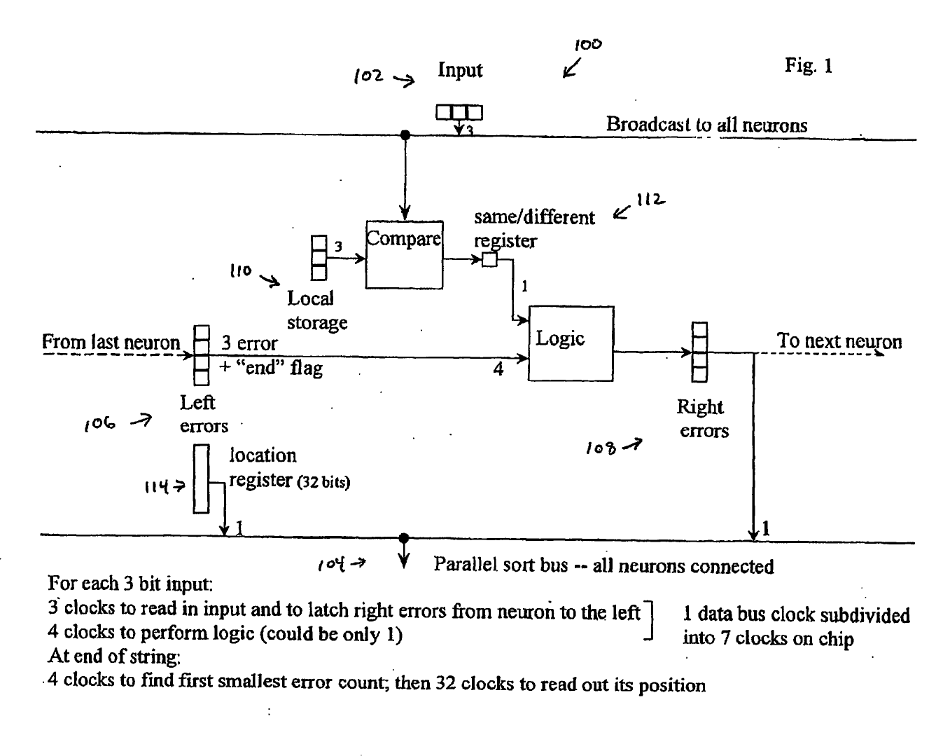

FIG. 1 is a schematic diagram of a string search neuron 100 of the present invention as optimized for DNA/RNA sequences. This basic neuron would be duplicated many times (e.g. thousands of times) on a semiconductor chip. All neurons share common input and output busses 102/104. In addition, there is communication to two neighbor neurons. The neurons are arranged in a single sequence from the first to the last on a chip. Logically they can be referred to as a left to right arrangement where the error register and end flags of the neighbor to the left feeds the current neuron, and the error register and end flags of the current neuron feeds the neuron on the right. Actual layout on the chip can be any layout that retains this logical flow of information. Typically the input and parallel sort busses would be only 1 bit wide, but the error register information from neighbor neurons could be parallel since the connections have to be maintained for only the short distance between adjacent cells (neurons). The input would be applied in serial order but received by all neurons simultaneously. Likewise, the parallel sort bus is connected to all neurons, and it has two functions. After the input string is completed and each neuron has its own error measure stored in its right_errors register, then the parallel sort bus participates in a parallel sort procedure as taught in the prior art.

At the start of the operation, the string to be searched is entered into the system with one character stored per neuron in sequential order at local storage 110. All left_errors and right errors registers 106, 108 are reset to “0”. When one character is entered into the system input (preferably in serial order), all neurons compare it to their own stored character at comparator/logic 112. If it is the same, right_errors=left_errors. If it is different, left_errors is incremented by one and passed to the right_errors register. After all of the characters of the input sub string have been entered, each neuron will have the number of errors ending with its position stored in its right_errors register. It remains to find that register which has the minimum number of errors.

To review the previously taught parallel sort procedure, it is as follows: Each neuron has an active bit (not shown) which is initially set to true. Each active neuron places its most significant error bit on the parallel sort bus through an open collector transistor. If any neuron is presenting a 0 to the wired OR circuit, the bus will be at its “0” level. Any neuron which is presenting a “1” when the bus is at “0” will turn its active bit off. This procedure is repeated for each less significant error bit in turn, and then for each location register bit 114 starting with the most significant location register bit. At the end of this procedure, only one active neuron will remain. It will represent the smallest error and the smallest location number (in case of ties). The second function of the output register is to read out the minimum error and the location register of the one remaining active neuron. This requires no additional clock cycles as the smallest error and the corresponding active neuron location register are the ones impressed on the common parallel sort bus during the sort operation.

Table 1 is a printout of the source code in the “C” language for a computer simulation of a search string neuron of this invention.

TABLE 1
(Simulation of string search neuron)

/* ********************************** */
#define MAX_NEURONS 1000 /* maximum number of neurons per chip
*/

| | | |
|---|---|---|
| #define L | 12 | /* inquiry length */ |

#include <stdio.h>
#include <stdlib.h>
#include <malloc.h>
#include <conio.h>
#include <string.h>
#include <math.h>
unsigned char query[100]= “aagcttgtcaag” ;
unsigned char storedstring[1000]=
“atcgatcgatcaatcgattagcttgtcaagcgatcaatcgatcaagcttgtcaaggatcaa
tcgatcgatcaatcgatcgatcaatcgatcgatcaatcgatcgatcaatcgatcgatcaatc
gatcgatcaatcgatcgatcaatcgatcgatcaatcgatcgatcaatcgatcgatcaatcga
tcgatcaatcgatcgatcaatcgatcgatcaatcgatcgatcaatcgatcgatcaatcgatc
gatcaatcgatcgatca” ;
int i,j,k ;
int mini ;
unsigned char min ;
FILE *pout ;
void reset (void) ;
void restore (void) ;
void neuron (void) ;
void find_best_match (void) ;

| | |
|---|---|
| /* ******************************************** | */ |
| /* | */ |
| /* Internals of the neurons | */ |
| /* storage for MAX_NEURONS neurons | */ |
| /* ******************************************** | */ |

unsigned char input ; /* common--broadcast to all neurons */
unsigned char localbasepair[MAX_NEURONS] ;
unsigned char storedend[MAX_NEURONS] ;

| | |
|---|---|
| unsigned char errors[MAX_NEURONS] ; | /* corresponds to “right |

errors in patent writeup */

/* left errors =

errors[i−1] */

| | |
|---|---|
| unsigned char end[MAX_NEURONS] ; | /* end has been |

encountered in string so far */
/* unsigned char is actually too much storage.
input should be 2 bits
localbasepair should be 2 bits/neuron
storedend should be 1 bit/ neuron
errors should be 3 bits/neuron (but could be more or less)
end should be 1 bit/neuron
*/
void main ( )
{
/*TEMP*/ pout = fopen(“out.dat”,“w”);
reset( ); /* reset chip */
restore( ) ; /* store string up to MAX_NEURONS long in ZISC */
/* Enter inquiry of any length L */
for (j=0;j<L;j++) {

input=query[j];
neuron( ) ;
/*TEMP*/fprintf(pout,“\nafter pass # %d, errors:\n”,j) ;
/*TEMP*/for (k=0;k<100;k++)

/*TEMP*/fprintf(pout,“%2d”,errors[k]) ;

}
find_best_match( );
/* Report from host processor */
printf (“\n Best match occurs at string position %d\n”,mini);
printf (“number of errors = %d\n”,min) ;
printf (“matching string starts with %c%c%c%c%c%c%c%c%c%c”,

storedstring[mini−L+1],storedstring[mini−L+2],
storedstring[mini−L+3],storedstring[mini−L+4],
storedstring[mini−L+5],storedstring[mini−L+6],
storedstring[mini−L+7],storedstring[mini−L+8],
storedstring[mini−L+9],storedstring[mini−L+10]) ;

printf (“\nerrors array\n”);
for(i=0;i<100;i++)

printf (“%2d”,errors[i]);

return ;
} /* end of main */
/* repeat all above and enter next query */

| | |
|---|---|
| /* ****************************************** | */ |
| /* Reset the chip(s). | */ |
| /* ****************************************** | */ |

void reset(void)
{

for(i=0;i<MAX_NEURONS;i++) {

localbasepair[i]=0 ;
storedend[i]=0 ;
errors[i] = 0 ;
end[i] = 0 ;

}
return;

} /* end of reset */

| | |
|---|---|
| /* ****************************************** | */ |
| /* Save/Restore mode | */ |
| /* loads stored string into neurons | */ |
| /* ****************************************** | */ |

void restore(void)
{

for (i=0;i<MAX_NEURONS;i++)

localbasepair[i] = storedstring[i] ;

return;
} /* end of restore */

| | |
|---|---|
| /* ********************************************** | */ |
| /* The neurons execute one data-input clock | */ |
| /* cycle for the ZISC chip. | */ |
| /* ********************************************** | */ |

void neuron ( )
{
for(i=MAX_NEURONS−1;i>0;i−−) {

if (input = = localbasepair[i]) errors[i]=errors[i−1] ;
else errors[i] = errors[i−1]+1 ;
if (errors[i−1]>=7) errors[i] = 7 ;
if (storedend[i]= =1 || end[i−1]= =1)

{ end[i]=1 ; errors[i] = errors[i−1] ; }

} /* end of compare mode */
/* in parallel operation, errors[i−1] and end[i−1]
must be latched for neuron i so that they don't
change during the above logical operations */
return;
} /* end neuron */

| | |
|---|---|
| /* *************************************************** | */ |
| /* Find_best_match | */ |
| /* Finds the smallest errors [.] in the array, | */ |
| /* returns location i, errors[i], end[i] | */ |
| /* On chip, use patented parallel search | */ |
| /* technique just like on standard ZISC. | */ |
| /* Also, as on the standard ZISC, the first | */ |
| /* return of best neuron disables that neuron | */ |
| /* so that subsequent requests will find ties | */ |
| /* same error number and higher location, or next | */ |
| /* higher error number. | */ |
| /* Here I will have to use a serial search(sorry) | */ |
| /* *************************************************** | */ |

void find_best_match(void)
{
min=10;

for (i=L;i<MAX_NEURONS;i++) {

if (errors[i] < min) {min=errors[i] ; mini = i; }
/* alternate mode: if (errors[i] < min && end[i]= =0)
{min=errors[i] ; mini = i ;} */

}
return ;

| | |
|---|---|
| } /* end find_best match | */ |

/* Comments for implementing in chip */

| | |
|---|---|
| /* | lines with *TEMP* are for debugging and illustration |

The external file is not required for the chip.
On the other hand, disk files are appropriate instead
of initializing the arrays query and storedstring. */

/* Note that, with the wired in example, errors = 1 at
position 29; errors = 0 at position 54 (the right answer)
and = 7 (no match) almost everywhere else.
Note also that the error if any can even be in the first

| | |
|---|---|
| position in the string! | */ |
| /* Comments on operation */ | |

/* Note that at the end of an input-data clock cycle each
errors[i] register contains the number of errors so far in
the string ending with the corresponding neuron.
After the next input-data clock cycle (entering of the next
base-pair, each errors register will have shifted to the
next higher neuron number and will represent the errors in
a string which is one longer in length. This is quite
evident in the file out.dat after running this program. */

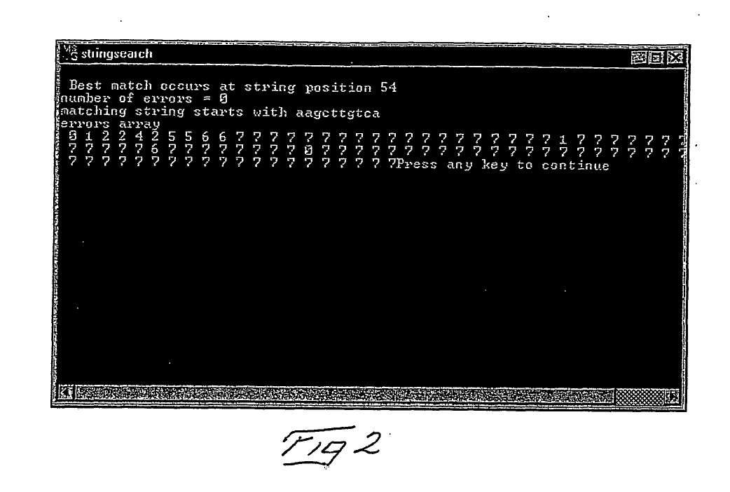

FIG. 2 is a printout of a console output from a program string search. This is a simulation of the system using the program listed in Table 1. In this simulation it is desired to find the sub string aagcttgtca in the longer DNA sequence, “atcgatcgatcaatcgattagcttgtcaagcgatcaatcgatcaagcttgtcaaggatcaatcgatcgatcaatcgatcgatcaatcgat cgatcaatcgatcgatcaatcgatcgatcaatcgatcgatcaatcgatcgatcaatcgatcgatcaatcgatcgatcaatcgatcgatca atcgatcgatcaatcgatcgatcaatcgatcgatcaatcgatcgatcaatcgatcgatcaatcgatcgatcaatcgatcgatca”.

The console output indicates that the best match occurs at string position 54 where the number of errors=0 (perfect match). The listing of right_errors registers shows that most starting positions yield a “7” or “no match”, one position yields the perfect match, and another position yields a “1” error.

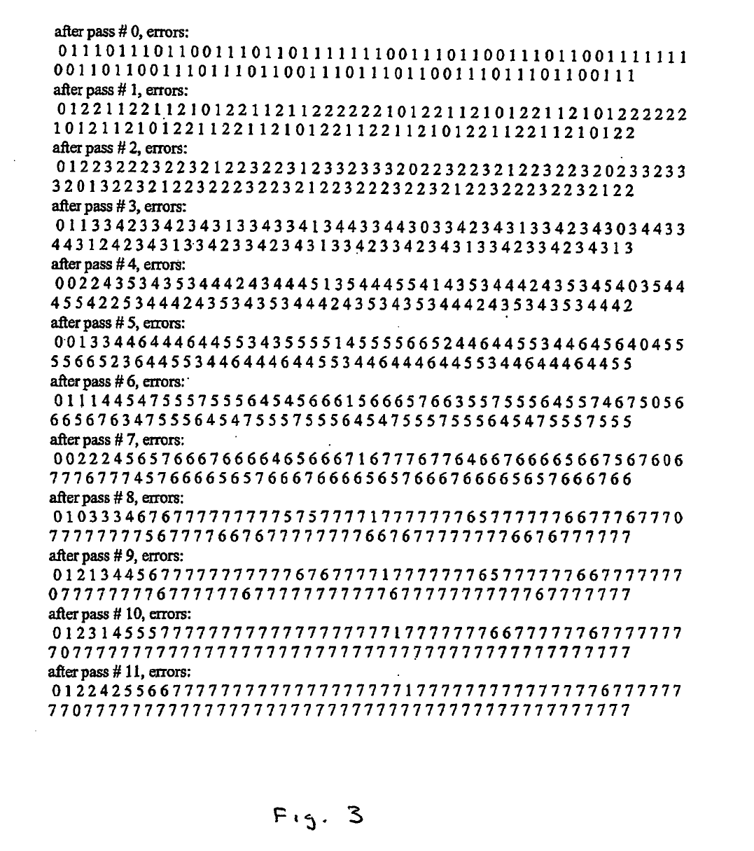

FIG. 3 is a printout of the output data of a simulated string search for a string of 12 characters showing search results for each clock cycle for 12 successive cycles. This shows the contents of the right_errors registers after each character has been input. After the first “a” has been entered, all neurons containing an “a” show an error of “0”, and all others show an error of “1”. After the second “a” has been entered, all neurons containing the second “a” in a row show an error of “0” and the others will be at “1” or “2” errors. At the end of the entry of the 12^{th} character, almost all of the start positions yielded maximum error with only three neurons reporting matches with 0, 1, and 6 errors. (Note: ignore the first 12 neurons. The error register into the first neuron should always be the maximum value, but was left at 0 in this simulation.) Note that the position of the minimum error moves one position to the right after every input cycle.

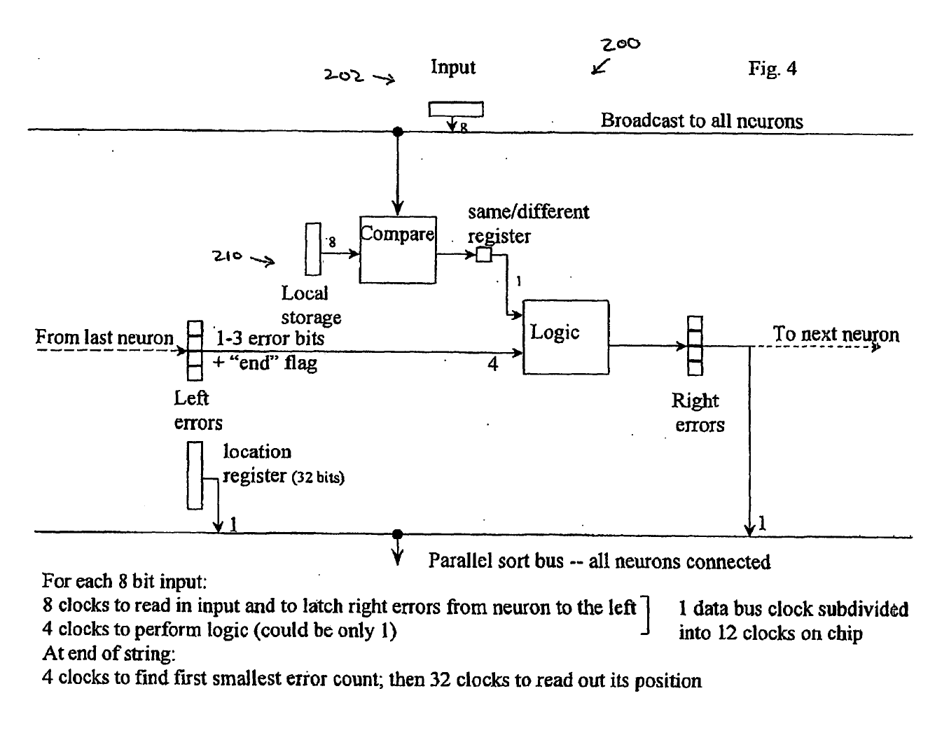

FIG. 4 is a schematic diagram of an alternate string search neuron 200 of the present invention, but optimized for finding text strings in a larger body of text. The operation for full text is exactly the same as described for finding DNA sequences (FIG. 1) except that the number of bits for input 202 and local storage 210 would be increased from 3 to 8 (or possibly more).

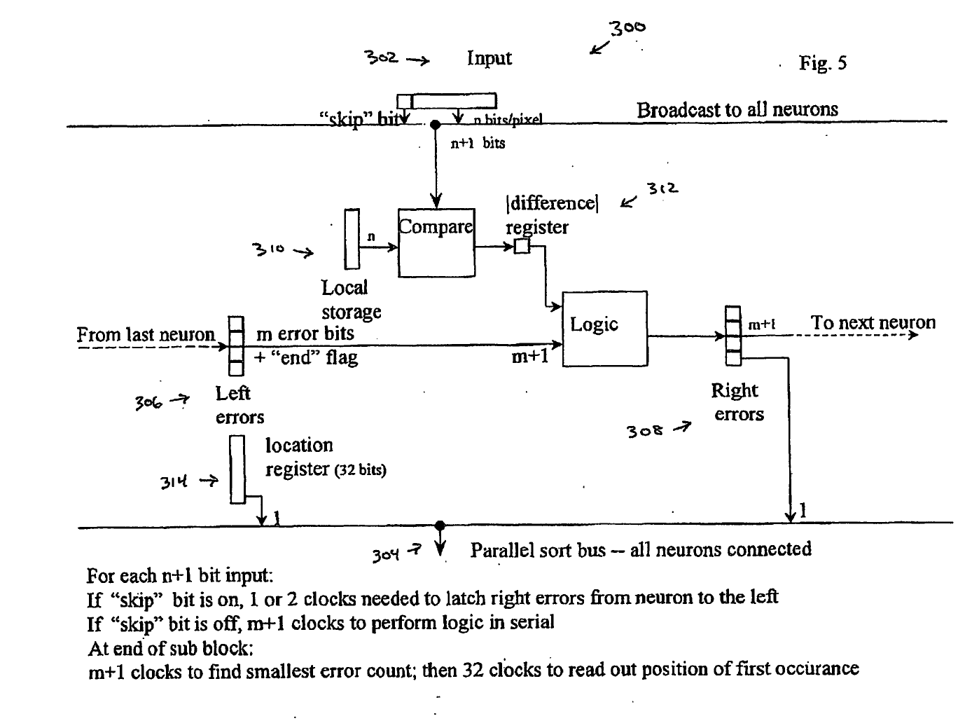

FIG. 5 is a schematic diagram of an alternate string search neuron 300 of the present invention, organized for search of image sub blocks in a larger image. This has application in image compression wherein finding a similar sub block previously stored or transmitted allows storage or transmission of only the location of the sub block rather than repeating all the pixels in the sub block. This is of particular value in compressing video frames wherein objects move from frae to frame without substantial change other than location.

This preferred embodiment of the string search neuron applied to images will now be described. Although there are some differences especially in terminology, the similarities of this embodiment to the previously described embodiments will become evident.

Again the neurons are lined up in order, in this case the order of storage of multidimensional arrays in conventional computer memories. In the case of a 2-dimensional array, for example, all of the elements (pixels) of one row are stored and followed by all the elements of the next row, etc.

The inputs, outputs and contents of each neuron in the system include:

(1) One pixel value: probably 8, 12, or 16 bits.

(2) Left_errors Register 306: Accumulated errors from the last neuron/left neighbor; m bits of storage

(3) Right_errors Register 308: Accumulated errors to be passed to the next neuron/right neighbor; m bits of storage

(4) Parallel Sort Bus 304: preferably one (1) bit ORed with all the other neurons in the system; and

(5) Neuron number or location register 314: preferably having a sufficient number of bits to give a unique number to each neuron.

The operation of the inventive string search preferably includes the following steps:

At the start of the operation, all left_errors and right_errors registers are reset to “0”.

The sub block to be found is organized into a sequence of pixels with the pixels of each row (or column) concatenated with those of the previous row (or column), but separated by a number of “skip” characters to pad the number of pixels plus “skip”s in the sub block to be equal to the width of the full image. For example, if the size of the sub block is x by y pixels and the size of the larger image is u by v pixels, then the organization of the sequence of pixels would be x pixels from the first row followed by (u−x) “skip” characters, followed by x pixels from the next row, followed by (u−x) “skip” characters, etc. The rows beyond row y need not be represented by “skip” characters.

In the preferred embodiment, the “skip” character would be just a single bit (e.g. a 1). A pixel to be compared would then be represented by a 0 followed by the n bits of the pixel.

When the first pixel of the sub block is entered into the system input 302, all neurons compare it at comparator/logic 312 to their own pixel value stored at local storage 310. If it is the same, right_errors=left_errors. If it is different, two different modes are defined to measure either L₁ or Lₛᵤₚ distance as in the standard ZISC. If the first mode is chosen, then right_errors=left_errors+absolute value of the difference of the pixels. If the second mode is chosen, then right_errors=(the greater of left_errors or absolute value of the difference of the pixels). In either case, right_errors is passed to the right to be clocked into the left_errors register of the next neuron in the left to right arrangement.

The number of bits input per pixel is 1 more than the number of bits representing each pixel. The first bit is the “skip” bit. If the “skip” bit is entered in the input, the number of errors is not changed, but merely shifted one neuron to the right. This operation can be executed much faster than a comparison of a full pixel.

This operation continues for all of the pixels in the input sub block. At the end of the sub block of y*u inputs, each right errors register will record the L₁ or Lₛᵤₚ distance in the y*u neurons to the left of its position in the sequence (including itself). At this time a parallel search in the manner of a standard ZISC search is performed. This will output the value of the smallest right_error of any neuron in the system and its location (its neuron number). If this number is less than a threshold, then a match has been detected and appropriate action can be taken (such as coding only the location as a proxy for the entire sub block).

Advantages of this embodiment, as compared to standard ZISC technology, include but are not limited to the following:

(1) The sub block can be entered into the system only once to be compared against every possible position in the larger image, instead of once per possible starting position.

(2) The sizes of the sub block and the larger image are not restricted except by the total number of neurons in the system.

(3) Each neuron of this type is much smaller than the standard ZISC neuron, thus making possible chips with many more neurons on a chip using the same chip technology.

As described above, the system will find the best match of a sub block to any position in the larger image. Even though “skip” characters can be handled far faster than pixels, it may be desirable to reduce the number of “skip” characters to increase speed. If the “u” is much larger than “x” and if it can be assumed that the sub block can't move very far from frame to frame, then a speedup can be effected by loading in only a portion of the larger image at a time such that “u” is only slightly larger than “x” and that the number of “skip” characters can be reduced. There is no need to reduce the number of rows “v” stored except as restricted by the number of neurons available in the system.

While this invention has been described in connection with preferred embodiments thereof, it is obvious that modifications and changes therein may be made by those skilled in the art to which it pertains without departing from the spirit and scope of the invention. Accordingly, the scope of this invention is to be limited only by the appended claims and their legal equivalents.

What is claimed as invention is:

1. A string search neuron for an artificial neural network system for use in matching strings of characters from a character set, said neuron comprising:
an input portion adapted for receipt of a first character in a string of characters from the character set from the system;
a local storage portion including one stored character from the character set;
a comparator/logic portion adapted to compare the first character received from said input portion with the stored character in said local storage portion; and to generate a same/different register entry, a left_errors register entry, and a right_errors register entry, in accordance with the following rules:
if it is the same, right_errors=left_errors, if it is different, left_errors is incremented by one and passed to the right_errors register; after all of the characters of the input sub string have been entered, each neuron will have the number of errors ending with its position stored in its right_errors register; and
at the end of a search, a parallel search in the manner of a standard ZISC search is performed to output the value of the smallest right error of any neuron in the system and its location.

2. The string search neuron of claim 1 wherein said character set comprises from three to eight characters.

3. The string search neuron of claim 1 wherein said character set comprises A, G, C, and T.

4. The string search neuron of claim 1 wherein said input portion comprises at least 3 bits of storage.

5. The string search neuron of claim 1 wherein said local storage portion comprises at least 3 bits of storage.

6. The string search neuron of claim 1 wherein said same/different error register comprises at least 1 bit of storage.

7. The string search neuron of claim 1 wherein said left error register comprises at least 3 bits of storage.

8. The string search neuron of claim 1 wherein said right error register comprises at least 3 bits of storage.

9. The string search neuron of claim 1 including a plurality of neurons lined up in order.

10. The string search neuron of claim 1 including a plurality of neurons, and a first string of base pairs individually stored therein.

11. The string search neuron of claim 10 including a plurality of neurons, and a second string of base pairs entered into the system one character at a time.

12. The string search neuron of claim 11 wherein said second string of base pairs is broadcast to all of the neurons in the system.

13. The string search neuron of claim 10 wherein said first string of base pairs is divided into sub strings.

14. The string search neuron of claim 12 wherein said second string of base pairs is divided into sub strings.

15. The string search neuron of claim 11 wherein said first string and said second string of base pairs are concatenated together.

16. The string search neuron of claim 1 wherein said character set includes a character representing unknown.

17. The string search neuron of claim 5 wherein said character set includes a character representing the end of a particular string.

18. The string search neuron of claim 1 wherein said neuron includes a parallel sort bus interconnected with adjacent neurons.

19. The string search neuron of claim 18 wherein said parallel sort bus comprises at least one bit of storage.

20. The string search neuron of claim 18 wherein said parallel sort bus communicates with adjacent neurons in a feedback signal.

21. The string search neuron of claim 1 wherein said neuron includes a location register.

22. The string search neuron of claim 21 wherein said location register comprises at least 32 bits of storage.

23. The string search neuron of claim 1 wherein said input portion comprises three clocks to read in input.

24. The string search neuron of claim 1 wherein said neuron comprises three clocks to latch right_errors from the neuron to the left.

25. The string search neuron of claim 1 wherein said neuron comprises four clocks to perform logic.

26. The string search neuron of claim 24 wherein said neuron comprises one subdivided data bus clock.

27. The string search neuron of claim 25 wherein said neuron comprises one subdivided data bus clock.

28. The string search neuron of claim 1 wherein said neuron comprises four clocks to find the first smallest error count.

29. The string search neuron of claim 28 wherein said neuron comprises at least 32 clocks to read out position.

30. The string search neuron of claim 21 wherein said location register comprises RAM that is loaded as part of initialization.

31. A string search neuron for an artificial neural network system for use in matching strings of pixels from an image, said neuron comprising:
an input portion adapted for receipt of a first pixel from the image to be searched;
a local storage portion including one stored pixel from the image to be searched;
a comparator/logic portion adapted to compare the first pixel received from said input portion with the stored pixel in said local storage portion; and to generate a same/different register entry, a left_errors register entry, and a right_errors register entry, in accordance with the following rules:
if it is the same, right_errors=left_errors, if it is different, two different modes are defined to measure either L₁ or Lₛᵤₚ distance as in the standard ZISC; if the first mode is chosen, then right_errors=left_errors+absolute value of the difference of the pixels; and if the second mode is chosen, then right_errors=(the greater of left_errors or absolute value of the difference of the pixels), so that right_errors is passed to the right to be clocked into the left_errors register of the next neuron in the left to right arrangement.

32. The string search neuron for an artificial neural network system for use in matching strings of pixels from an image of claim 31 wherein the number of bits input per pixel is 1 more than the number of bits representing each pixel.

33. The string search neuron for an artificial neural network system for use in matching strings of pixels from an image of claim 31 wherein the operation continues for all of the pixels in the input sub block; at the end of the sub block of y*u inputs, each right_errors register will record the L₁ or Lₛᵤₚ distance in the y*u neurons to the left of its position in the sequence; and a parallel search in the manner of a standard ZISC search is performed to output the value of the smallest right_error of any neuron in the system and its location.
